(19) United States
(12) Patent Application Publication
(10) Pub. No.: US 2006/0058410 A1
(43) Pub. Date: Mar. 16, 2006

(54) Process for making a PIPA-polyol

(75) Inventors: Jianming Yu, Brussels (BE); Albert Gabriel Verhelst, Boortmeerbeek (BE)

Correspondence Address: HUNTSMAN POLYURETHANES;Patent Counsel, 10003 Woodloch Forest Drive, The Woodlands, TX, 77380, US

(73) Assignee: Huntsman International LLC, Salt Lake City, UT (US)

(21) Appl. No.: 11/267,921

(22) Filed: Nov. 3, 2005

Related U.S. Application Data
(63) Continuation of application No. PCT/EP04/50369, filed on Mar. 26, 2004.

(30) Foreign Application Priority Data
May 12, 2003 (EP) 03010560.5

(51) Int. Cl. C08G 18/00

(52) U.S. Cl. 521/155

(57) ABSTRACT

Process for preparing a polyol comprising particulate material in dispersed form by reacting an MDI-based polyisocyanate and a polyol having an equivalent weight of up to 400, the reaction being carried out in a polyol having an equivalent weight of 500 or more wherein the polyol having an equivalent weight of 500 or more is a polyoxyethylene polyoxypropylene polyol having an oxyethylene content of 15-49% by weight calculated on the total oxyalkylene groups present wherein 20-80% of the oxyethylenegroups resides at the end of the polymer chains.

### CROSS REFERENCE TO RELATED APPLICATIONS

This application is a continuation of international application PCT EP2004/050369, filed Mar. 26, 2004, which claims priority to EP 03010560.5, filed May 12, 2003, both of which applications are hereby incorporated by reference.

### FIELD OF THE INVENTION

The present invention is concerned with a process for preparing PIPA polyols, such PIPA polyols and the use of such PIPA polyols in making polyurethanes.

### BACKGROUND OF THE INVENTION

PIPA (polyisocyanate polyaddition) polyols have been disclosed before. See e.g. U.S. Pat. No. 4,452,923, U.S. Pat. No. 4,438,252, U.S. Pat. No. 4,554,306, GB 2102822, GB 2072204, WO 94/12553, U.S. Pat. No. 5,292,778 and EP 418039. PIPA polyols are polyaddition reaction products of a polyisocyanate and a low molecular weight compound having a plurality of hydroxyl, primary amine and/or secondary amine groups in the presence of high molecular weight polyols, in particular polyether polyols. The PIPA polyol is a dispersion of particulate material in a polyol and is used e.g. in making slabstock or moulded flexible foams with improved load-bearing properties. The amount of PIPA polyol used in formulations for making such foams conventionally is such that the amount of particulate material calculated on all high molecular weight polyol used in the formulation is 1-15% by weight. The most commonly used PIPA polyol nowadays probably is a PIPA polyol having about 20% by weight of particulate material, which is diluted with further high molecular polyol to the above 1-15% by weight loading range.

It is also desirable to be able to provide PIPA polyol with a considerably higher loading. It would allow the foam producer to use PIPA polyol with higher loadings for making the foam. Even if the foam producer would dilute the PIPA polyol with a higher loading, it would have the advantage that the PIPA polyol can be transported in a more concentrated form and is diluted at the place where it is needed and to the extent needed. Further, it provides the polyurethane systems' formulator with less formulation restrictions. The foams made from such PIPA polyols show good fire retardancy properties and are easily recyclable. Processes for making such PIPA polyols, with a higher loading, are known. See e.g. the prior art mentioned before. However, these processes lead to products that have a high viscosity and/or are not stable or these processes lead, certainly at a larger scale, to an uncontrollable reaction that gives PIPA polyols that could cause foam collapse when used in making flexible polyurethane foams. WO 00/73364 relates to a process for preparing a PIPA-polyol having a loading of 30-80% by weight and a relatively low viscosity. When used in making flexible foams, such PIPA polyols give a cell opening effect that often is too strong and a reinforcing effect that is too low; further, the compression set and the fire performance of the foam would need improvement.

### SUMMARY OF THE INVENTION

Surprisingly, a novel PIPA-polyol has been found that shows good stability and a relatively low viscosity, also at higher loadings. Further, foams made from such PIPA-polyols show improved load-bearing characteristics at comparable densities. Still further, when making moulded foams using such PIPA-polyols good mouldings were obtained while mouldings made from traditional PIPA-polyols showed internal defects.

Therefore, the present invention is concerned with a polyol composition comprising particulate material in dispersed form in a polyol having an average equivalent weight of 500 or more and in an amount of 1-80% by weight calculated on the total polyol composition, this composition having a viscosity of 1500-25000 mPa·s at 25° C. and the particulate material comprising reaction products of a polyol having an average equivalent weight of up to 400 and of diphenylmethane diisocyanate optionally comprising homologues thereof having an isocyanate functionality of 3 or more and/or modified variants of such polyisocyanates, wherein the polyol having an equivalent weight of 500 or more is a polyoxyethylene polyoxypropylene polyol having an oxyethylene content of 15-49% and preferably of 21-45% by weight calculated on the total oxyalkylene groups present wherein 20-80% of the oxyethylene groups resides at the end of the polymer chains.

### DETAILED DESCRIPTION OF THE INVENTION

The present invention is concerned with a polyol composition comprising particulate material in dispersed form in a polyol having an average equivalent weight of 500 or more and in an amount of 1-80% by weight calculated on the total polyol composition, this composition having a viscosity of 1500-25000 mPa·s at 25° C. and the particulate material comprising reaction products of a polyol having an average equivalent weight of up to 400 and of diphenylmethane diisocyanate optionally comprising homologues thereof having an isocyanate functionality of 3 or more and/or modified variants of such polyisocyanates, wherein the polyol having an equivalent weight of 500 or more is a polyoxyethylene polyoxypropylene polyol having an oxyethylene content of 15-49% and preferably of 21-45% by weight calculated on the total oxyalkylene groups present wherein 20-80% of the oxyethylene groups resides at the end of the polymer chains.

The viscosity is measured using a Brookfield Viscometer, model DV-II with a spindle CP-41.

Further, the polyol composition according to the present invention preferably comprises particulate material of which at least 90% by volume has a particle size of 10 μm or less as measured using a Mastersizer 2000, from Malvern Instruments, equipped with a Hydro 2000/s dispersion accessory, using methanol as eluent. The content of particulate material is the sum of the amount of polyisocyanate and the amount of polyol having an equivalent weight of up to 400 used in making the polyol composition according to the present invention and is calculated by the following formula:

$$\frac{\begin{matrix}( weight of polyisocyanate + \\ weight of polyol with eq . weight of up to 400 ) 100\end{matrix}}{total weight of the polyol composition} , \% w .$$

It will be clear that in this calculation it is assumed that all reacted product gives particulate material and that no polyisocyanate reacts with the other polyol(s).

Preferably, at least 95% by volume, and most preferably, at least 99% by volume of the particles has a particle size of 10 μm or less.

The polyol compositions according to the present invention are made by a process wherein the polyol having an average equivalent weight of up to 400 and the polyisocyanate are allowed to react in the polyol having an average equivalent weight of 500 or more, wherein the number of NCO-groups in the polyisocyanate is 30-100% and preferably 40-80% of the number of OH-groups in the polyol having an equivalent weight of up to 400.

Further, we have found a process for preparing a polyol composition comprising a particulate material, the amount of particulate material being 1-80% by weight calculated on the total composition wherein diphenylmethane diisocyanate, optionally comprising homologues thereof having an isocyanate functionality of 3 or more and modified variants of such polyisocyanates, a polyol having an average equivalent weight of up to 400 and water are allowed to react in a polyol having an average equivalent weight of 500 or more, wherein the polyol having an equivalent weight of 500 or more is a polyoxyethylene polyoxypropylene polyol having an oxyethylene content of 15-49% by weight and preferably of 21-45% by weight calculated on the total oxyalkylene groups present wherein 20-80% of the oxyethylene groups resides at the end of the polymer chains.

In this process a small amount of water (0.1-5% by weight calculated on the amount of polyol composition) may be used.

The use of a small amount of water reduces the viscosity of the final polyol composition at comparable equivalent ratios of NCO-groups from the polyisocyanate and of OH-groups in the polyol having an average equivalent weight of up to 400.

Still further, the present invention is concerned with a blend of 1-99 parts by weight (pbw) and preferably of 5-95 pbw of a polyol composition according to the present invention and 1-99 and preferably 5-95 pbw of another polyether polyol having an average equivalent weight of 500 or more (than the one used to make the composition). Other polyether polyols include those having an other oxyethylene content and/or distribution.

In the context of the present application the following terms have the following meaning:
1) The expression “polyurethane foam” as used herein generally refers to cellular products as obtained by reacting polyisocyanates with isocyanate-reactive hydrogen containing compounds, using foaming agents, and in particular includes cellular products obtained with water as reactive foaming agent (involving a reaction of water with isocyanate groups yielding urea linkages and carbon dioxide and producing polyurea-urethane foams).

2) The term “average nominal hydroxyl functionality” is used herein to indicate the number average functionality (number of hydroxyl groups per molecule) of the polyol composition on the assumption that this is the number average functionality (number of active hydrogen atoms per molecule) of the initiator(s) used in their preparations although in practice it will often be somewhat less because of some terminal unsaturation. The term “equivalent weight” refers to the molecular weight per isocyanate reactive hydrogen atom in the molecule.

3) The word “average” refers to number average unless indicated otherwise.

The polyol having an average equivalent weight of 500 or more preferably has an average equivalent weight of 1000-5000 and an average nominal hydroxy functionality of 2-6 (hereinafter referred to as compound 1). More preferably, these polyols have an average equivalent weight of 1000-3000 and an average nominal hydroxy functionality of 2-4.

Compound 1 is selected from polyols obtained by the polymerization of ethylene oxide and propylene oxide in the presence of polyfuctional initiators. Suitable initiator compounds contain a plurality of active hydrogen atoms and include water, butanediol, ethylene glycol, propylene glycol, diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, sorbitol and sucrose. Mixtures of initiators may be used as well.

The following way of describing polyols is used in the present application: A PO-EO polyol is a polyol having first a PO block attached to the initiator followed by an EO block. A PO-PO/EO polyol is a polyol having first a PO block and then a block of randomly distributed PO and EO. A PO-PO/EO-EO polyol is a polyol having first a PO block and then a block of randomly distributed PO and EO and then a block of EO. In the above descriptions only one tail of a polyol is described (seen from the initiator); the nominal hydroxy functionality will determine how many of such tails will be present.

Compound 1 preferably has a structure of the type PO-PO/EO-EO or of the type PO/EO-EO. The total EO content is from 15 to 49 and preferably from 21 to 45% by weight (over the weight of the total oxyalkylene units present). Compound 1 has a primary OH content of at least 50%, preferably at least 70% based on the primary and secondary hydroxyl groups in the polyol. In the PO-PO/EO-EO type polyol, the first PO block comprises preferably from 20 to 90% by weight of the PO units. The polyol having a structure of the type PO-PO/EO-EO can notably be produced according to the teaching of U.S. Pat. No. 5,594,097. The polyol having a structure of the type—PO/EO-EO can notably be produced according to the teaching of U.S. Pat. No. 4,559,366. Most preferred structure is of the type PO-PO/EO-EO.

Mixtures of polyether polyols may be used as compound 1, provided the mixture has the characteristics described above for compound 1.

The polyol having an equivalent weight of up to 400 (hereinafter referred to as ‘compound 2’) preferably has an equivalent weight of up to 200 and may be selected from alkanolamines, low equivalent weight amine-initiated polyether polyols and low equivalent weight hydroxyl-terminated compounds such as ethylene glycol, glycerine, glycol ethers, pentaerythritol or mixtures thereof.

Suitable alkanolamines are di- and trialkanolamines, particularly those wherein the alkanol groups each have from 2 to 6, preferably 2 to 3 carbon atoms.

The most preferred compound is triethanolamine.

The polyisocyanate used in making the PIPA polyol may be selected from diphenylmethane diisocyanates (MDI) optionally comprising homologues thereof having an isocyanate functionality of 3 or more (such diisocyanate comprising such homologues are known as crude MDI or polymeric MDI or mixtures of such crude or polymeric MDI with MDI) and modified variants of such diphenylmethane diisocyanates optionally comprising such homologues.

The diphenylmethane diisocyanate (MDI) used may be selected from 4,4′-MDI, 2,4′-MDI, isomeric mixtures of 4,4′-MDI and 2,4′-MDI and less than 10% by weight of 2,2′-MDI, and modified variants thereof containing carbodiimide, uretonimine, isocyanurate, urethane, allophanate, urea and/or biuret groups. Preferred are 4,4′-MDI, isomeric mixtures of 4,4′-MDI and 2,4′-MDI and less than 10% by weight of 2,2′MDI and uretonimine and/or carbodiimide modified MDI having an NCO content of at least 20% by weight and preferably at least 25% by weight and urethane modified MDI obtained by reacting excess MDI and polyol having a molecular weight of at most 1000 and having an NCO content of at least 20% by weight and preferably at least 25% by weight.

Diphenylmethane diisocyanate comprising homologues having an isocyanate functionality of 3 or more are so-called polymeric or crude MDI.

Polymeric or crude MDI are well known in the art. They are made by the phosgenation of a mixture of polyamines obtained by the acid condensation of aniline and formaldehyde.

The manufacture of both the polyamine mixtures and the polyisocyanate mixtures is well known. The condensation of aniline with formaldehyde in the presence of strong acids such as hydrochloric acid gives a reaction product containing diaminodiphenylmethane together with polymethylene polyphenylene polyamines of higher functionality, the precise composition depending in known manner inter alia on the aniline/formaldehyde ratio. The polyisocyanates are made by phosgenation of the polyamine mixtures and the various proportions of diamines, triamines and higher polyamines give rise to related proportions of diisocyanates, triisocyanates and higher polyisocyanates. The relative proportions of diisocyanate, triisocyanate and higher polyisoycanates in such crude or polymeric MDI compositions determine the average functionality of the compositions, which is the average number of isocyanate groups per molecule. By varying the proportions of starting materials, the average functionality of the polyisocyanate compositions can be varied from little more than 2 to 3 or even higher. In practice, however, the average isocyanate functionality preferably ranges from 2.3-2.8. The NCO value of these polymeric or crude MDI is at least 30% by weight. The polymeric or crude MDI contain diphenylmethane diisocyanate, the remainder being polymethylene polyphenylene polyisocyanates of functionality greater than two together with by-products formed in the manufacture of such polyisocyanates by phosgenation of polyamines. Further modified variants of such crude or polymeric MDI may be used as well comprising carbodiimide, uretonimine, isocyanurate, urethane, allophanate, urea and/or biuret groups; especially the aforementioned uretonimine and/or carbodiimide modified ones and the urethane modified ones are preferred. Mixtures of polyisocyanates may be used as well.

The polyol compositions according to the present invention are prepared by allowing the polyisocyanate and compound 2 to react in compound 1. The order of addition may be varied but preferably compound 2 is added first to compound 1 followed by the polyisocyanate. The amount of polyisocyanate used is such that the number of isocyanate groups (NCO-groups) is 30-100% and preferably 40-80% of the hydroxy groups (OH-groups) in compound 2. The amount of polyisocyanate and compound 2 together reflects the desired amount of particulate material in compound 1; if one wishes to prepare a polyol with 25% by weight of particulate material then the amount of polyisocyanate and compound 2 together is 25% by weight of the total composition (compound 1+compound 2+polyisocyanate). The amount of particulate material preferably is 5-60% by weight.

The ingredients, once combined, are allowed to react. The combination of the ingredients may be conducted at ambient or elevated temperature by mixing. Because the reaction is exothermic no further heating is needed once the reaction starts; often cooling is desirable, particularly at the end of the reaction.

A preferred process is a process wherein:
compound 2 is emulsified in compound 1 at a temperature of 40-100° C. under high shear mixing conditions,
a polyisocyanate is added gradually to the emulsion so formed while maintaining the temperature between 60-150° C. and while maintaining high shear conditions,
the reacting mixture, obtained after all polyisocyanate has been added, is allowed to react further for a period of time of 10 minutes—2 hours while maintaining the temperature between 60-130° C.,
the high shear mixing is discontinued, and optionally
the polyol so obtained is cooled to ambient temperature.

In order to reduce the viscosity of a PIPA polyol composition according to the present invention, it is preferred to use a small amount of water in the preparation of such polyol composition. Generally, the amount is 0.1-5% by weight calculated on the total amount of the polyol composition and preferably 0.1-2% by weight calculated on the same basis. The water may be added at any stage but preferably it is added to compound 2 or the mixture of compound 1 and 2. So, in one aspect of the present invention, 0.1-5% by weight of water is used when preparing the polyol composition according to the present invention using an MDI polyisocyanate in an amount such that the number of NCO-groups is 30-100% and preferably 40-80% of the number of OH-groups in compound 2.

In another aspect, a polyol composition is prepared, the composition comprising particulate material in dispersed form in a polyol having an average equivalent weight of 500 or more and the amount of particulate material being 1-80% by weight calculated on the total polyol composition, the composition having a viscosity of 1500-25000 mPa·s at 25° C., by reacting in the above polyol, a polyol having an average equivalent weight of up to 400, a diphenylmethane diisocyanate optionally comprising homologues thereof having an isocyanate functionality of 3 or more and/or modified variants of such polyisocyanates, and water in an amount of 0.1-5% by weight calculated on the total polyol composition, and wherein the polyol having an equivalent weight of 500 or more is a polyoxyethylene polyoxypropylene polyol having an oxyethylene content of 15-49% by weight and preferably of 21-45% by weight calculated on the total oxyalkylene groups present wherein 20-80% of the oxyethylene groups resides at the end of the polymer chains. The aforementioned preferences also apply to this process.

The PIPA-polyols according to the present invention are useful for making flexible polyurethane foams including reacting a polyisocyanate and a polyol composition according to the present invention or a blend according to the present invention in the presence of a blowing agent.

In particular, slabstock flexible polyurethane foams and moulded flexible polyurethane foams can be made from such PIPA-polyols. The polyols are particularly useful in making so called foam in fabric or pour in place mouldings because the amount of “strike-through” is reduced.

### EXAMPLES

A PIPA-polyol 1 was made using DALTOCEL F428 polyol (available from Huntsman Polyurethanes) as carrier polyol, triethanolamine (TELA, 99% pure) and SUPRASEC 2020 isocyanate (available from Huntsman Polyurethanes). DALTOCEL F428 polyol is an PO-EO polyol having a nominal functionality of 3, an EO-tip content of about 15% by weight and an OH value of 28 mg KOH/g. SUPRASEC 2020 isocyanate is a uretonimine—modified polyisocyanate having a NCO-value of 29.5% by weight. DALTOCEL and SUPRASEC are trademarks of Huntsman International LLC. PIPA-polyol 1 was made according to WO 00/73364 at a solids content of 48% by weight.

PIPA-polyol 2 was made as follows:

30 kg of polyol 2 was blended with 6.92 kg of TELA for 30 minutes under high shear mixing. Then 13.08 kg of SUPRASEC 2020 isocyanate was added gradually over 60 minutes while keeping the temperature at 120° C. under high shear mixing. After completion of the polyisocyanate addition, stirring of the dispersion is continued for another 60 minutes while cooling the mixture to 90° C. Then mixing was stopped and the dispersion was allowed to cool down to ambient temperature. The PIPA-polyol 2 obtained had a viscosity of 8800 mPa·s at 25° C., a solids content of 40% by weight and all particles had a size below 10 μm (viscosity, solids content and particle size were determined as described hereinbefore). Polyol 2 is a glycerol-initiated polyol of the type PO-PO/EO-EO with a distribution (in % w) of 55-16/14-15 and an OH value of 28 mg KOH/g.

The above made PIPA-polyols 1 and 2 were used to make flexible polyurethane foams (free rise and mouldings) from the following ingredients (amounts are in parts by weight, pbw); see Table 1. All ingredients, except the polyisocyanates, were premixed with each other before they were contacted with the polyisocyanate. The physical properties of the foams are given in Table 2.

TABLE 1

| | Experiment Number | | | | | |
|---|---|---|---|---|---|---|
| | 1* | 2* | 3 | 4* | 5 | 6* |
| DALTOCEL F428 polyol | 95 | 75 | 71 | — | — | 7 |
| PIPA-polyol 1 | — | 20 | — | — | — | 28 |
| PIPA-polyol 2 | — | — | 24 | — | 35 | — |
| Polyol 2 | — | — | — | 35 | — | — |
| Water | 4.5 | 4.5 | 4.5 | 2.5 | 2.5 | 2.5 |
| Polyol A | 5 | 5 | 5 | — | — | — |
| TEGOSTAB | 0.5 | 0.5 | 0.5 | 0.5 | 0.5 | 0.5 |
| B4113 surfactant | | | | | | |
| (available | | | | | | |
| from Goldschmidt) | | | | | | |
| Dimethylethanolamine | 0.5 | 0.5 | 0.5 | — | — | — |
| DABCO 8154 | 0.7 | 0.7 | 0.7 | — | — | — |
| catalyst (available | | | | | | |
| from Air Products) | | | | | | |
| Diethyltoluendiamine | 0.3 | 0.3 | 0.3 | — | — | — |
| DABCO 33LV | — | — | — | 0.6 | 0.6 | 0.6 |
| catalyst (available | | | | | | |
| from Air Products) | | | | | | |
| NIAX A1 | — | — | — | 0.1 | 0.1 | 0.1 |
| catalyst (available | | | | | | |
| from Osi | | | | | | |
| Polyisocyanate 1 | 67 | 67 | 67 | — | — | — |
| Polyisocyanate 2 | — | — | — | 110 | 110 | 110 |
| Solids in foam, % w | 0 | 5.5 | 5.5 | 0 | 9 | 9 |

*comparative example

Polyol A: a glycerol-based polyoxyethylene polyol having a nominal functionality of 3 and an OH value of 127 mg KOH/g.

Polyisocyanate 1: SUPRASEC 2591 isocyanate, a polyisocyanate obtainable from Huntsman Polyurethanes.

Polyisocyanate 2: A 91/4.5/4.5 w/w/w blend of prepolymer A/SUPRASEC 2020 isocyanate/10 SUPRASEC 2185 isocyanate wherein prepolymer A is the reaction product of 30 parts by weight of 4,4′-MDI and 70 parts by weight of DALTOCEL F442 polyol, obtainable from Huntsman Polyurethanes.

TABLE 2
Properties of the Foam

| | Foam Number | | | | | |
|---|---|---|---|---|---|---|
| | 1* | 2* | 3 | 4* | 5 | 6* |
| Free rise foam | | | | | | |
| Recession, % | 4 | 9 | 6 | 12 | 7 | >50 |
| Free rise density, kg/m3, ISO845 | 32.7 | 36.9 | 32.9 | 54.2 | 55.2 | ** |
| Compression load deflection at 40%, kPa, ISO 3386-1 | 2.9 | 4.2 | 3.9 | 2.4 | 4.8 | ** |
| Moulded foam | | | | | | |
| Overall density, kg/m3, ISO 845 | 45 | *** | 45 | — | — | — |
| Compression load deflection at 40%, kPa, ISO 3386-1, | 4.8 | *** | 6.7 | — | — | — |
| Indentation load deflection at 40%, N, ISO2439-Method B. | 263 | *** | 358 | — | — | — |

** boiling foam, collapsed
*** internal defects
— not done

PIPA-polyol 3 was made as follows:

2.4 kg of polyol 3 was blended with 0.554 kg of TELA for 15 minutes under high shear mixing. Then 1.046 kg of SUPRASEC 2020 isocyanate was added gradually over 60 minutes while keeping the temperature at 120° C. under high shear conditions. After completion of the isocyanate addition, stirring of the dispersion is continued for another 60 minutes while cooling the mixture to 90° C. Then the mixing was stopped and the dispersion was allowed to cool down to ambient temperature. The PIPA-polyol 3 had a viscosity of 7100 mPa·s at 25° C., a solids content of 40% by weight and all particles had a size below 10 microns (all determined as before). Polyol 3 is a glycerol initiated polyol of the type PO-PO/EO-EO with a distribution (in % w) of 55-23/7-15 and an OH value of 30 mg KOH/g.

What is claimed:

1. A polyol composition comprising particulate material in dispersed form in a polyol having an equivalent weight of 500 or more and in an amount of 1-80% by weight calculated on the total polyol composition, the composition having a viscosity of 1500-25000 mPa·s at 25° C. and the particulate material comprising reaction products of a polyol having an equivalent weight of up to 400 and of diphenylmethane diisocyanate optionally comprising homologues thereof having an isocyanate functionality of 3 or more and/or modified variants of such polyisocyanates, the polyol having an equivalent weight of 500 or more is a polyoxyethylene polyoxypropylene polyol having an oxyethylene content of 15-49% by weight calculated on the total oxyalkylene groups present wherein 20-80% of the oxyethylene groups resides at the end of the polymer chains.

2. The polyol composition according to claim 1 wherein the number of isocyanate groups is 30-100% of the number of hydroxy groups in the polyol having an equivalent weight of up to 400.

3. The polyol composition according to claim 1 wherein the amount of particulate material is 5-60% by weight.

4. The polyol composition according to claim 1 wherein the polyol having an equivalent weight of 500 or more is of the type PO-EO/PO-EO wherein the first PO block comprises 20 to 90% by weight of the PO units and wherein the polyol having an equivalent weight of up to 400 is an alkanolamine wherein the alkanol groups each have 2-6 carbon atoms.

5. The polyol composition according to claim 1 wherein at least 90% by volume of the particles has a particle size of 10 μm or less.

6. A blend of: (a) 1-99 parts by weight (pbw) of a polyol composition comprising particulate material in dispersed form in a polyol having an equivalent weight of 500 or more and in an amount of 1-80% by weight calculated on the total polyol composition, the composition having a viscosity of 1500-25000 mPa·s at 25° C. and the particulate material comprising reaction products of a polyol having an equivalent weight of up to 400 and of diphenylmethane diisocyanate optionally comprising homologues thereof having an isocyanate functionality of 3 or more and/or modified variants of such polyisocyanates, the polyol having an equivalent weight of 500 or more is a polyoxyethylene polyoxypropylene polyol having an oxyethylene content of 15-49% by weight calculated on the total oxyalkylene groups present wherein 20-80% of the oxyethylene groups resides at the end of the polymer chains, and (b) 1-99 pbw of another polyether polyol, having an average equivalent weight of 500 or more, than the one used to make the composition.

7. A process for preparing a polyol composition comprising particulate material in dispersed form in a polyol having an equivalent weight of 500 or more and in an amount of 1-80% by weight calculated on the total polyol composition, the composition having a viscosity of 1500-25000 mPa·s at 25° C. and the particulate material comprising reaction products of a polyol having an equivalent weight of up to 400 and of diphenylmethane diisocyanate optionally comprising homologues thereof having an isocyanate functionality of 3 or more and/or modified variants of such polyisocyanates, the polyol having an equivalent weight of 500 or more is a polyoxyethylene polyoxypropylene polyol having an oxyethylene content of 15-49% by weight calculated on the total oxyalkylene groups present wherein 20-80% of the oxyethylene groups resides at the end of the polymer chains,
wherein the polyisocyanate and the polyol having an equivalent weight of up to 400 are allowed to react in the polyol having an equivalent weight of 500 or more, wherein the polyol having an equivalent weight of 500 or more is a polyoxyethylene polyoxypropylene polyol having an oxyethylene content of 15-49% by weight calculated on the total oxyalkylene groups present wherein 20-80% of the oxyethylene groups resides at the end of the polymer chains.

8. The process according to claim 7 wherein:
(a) the polyol having an equivalent weight of up to 400 is emulsified in the polyol having an equivalent weight of 500 or more at a temperature of 60-100° C. under high shear mixing conditions,
(b) the polyisocyanate is added gradually to the emulsion so formed while maintaining the temperature between 60-130° C. and while maintaining high shear conditions,
(c) the reaction mixture, obtained after all polyisocyanate has been added, is allowed to react further for a period of time of 10 minutes—2 hours while maintaining the temperature between 60-130° C.,
(d) the high shear mixing is discontinued, and optionally
(e) the polyol so obtained and comprising the particulate material in dispersed form is cooled to ambient temperature.

9. The process according to claim 7 wherein an amount of water is used which ranges from 0.1 to 5% by weight calculated on the total amount of the polyol composition.

10. The process according to claim 8 wherein an amount of water is used which ranges from 0.1 to 5% by weight calculated on the total amount of the polyol composition.

11. A process for making a flexible polyurethane foam including reacting a polyisocyanate and either (i) a polyol composition comprising particulate material in dispersed form in a polyol having an equivalent weight of 500 or more and in an amount of 1-80% by weight calculated on the total polyol composition, the composition having a viscosity of 1500-25000 mPa·s at 25° C. and the particulate material comprising reaction products of a polyol having an equivalent weight of up to 400 and of diphenylmethane diisocyanate optionally comprising homologues thereof having an isocyanate functionality of 3 or more and/or modified variants of such polyisocyanates, the polyol having an equivalent weight of 500 or more is a polyoxyethylene polyoxypropylene polyol having an oxyethylene content of 15-49% by weight calculated on the total oxyalkylene groups present wherein 20-80% of the oxyethylene groups resides at the end of the polymer chains, or
(ii) a blend of: (a) 1-99 parts by weight (pbw) of a polyol composition comprising particulate material in dispersed form in a polyol having an equivalent weight of 500 or more and in an amount of 1-80% by weight calculated on the total polyol composition, the composition having a viscosity of 1500-25000 mPa·s at 25° C. and the particulate material comprising reaction products of a polyol having an equivalent weight of up to 400 and of diphenylmethane diisocyanate optionally comprising homologues thereof having an isocyanate functionality of 3 or more and/or modified variants of such polyisocyanates, the polyol having an equivalent weight of 500 or more is a polyoxyethylene polyoxypropylene polyol having an oxyethylene content of 15-49% by weight calculated on the total oxyalkylene groups present wherein 20-80% of the oxyethylene groups resides at the end of the polymer chains, and (b) 1-99 pbw of another polyether polyol, having an average equivalent weight of 500 or more, than the one used to make the composition.
in the presence of a blowing agent.
